(19) United States
(12) Patent Application Publication
(10) Pub. No.: US 2026/0228683 A1
(43) Pub. Date: Aug. 6, 2026

(54) SYSTEMS AND METHODS FOR RETURNING UNWANTED ITEMS

(71) Applicant: Walmart Apollo, LLC, Bentonville, AR (US)

(72) Inventors: Tushar P. Dadlani, San Francisco, CA (US); Brittany N. Leek, Waterford, MI (US); Andrew J. Grignon, Roseville, CA (US); Darrell Whitelaw, Pacific Palisades, CA (US); Jae Y. Lew, Mill Valley, CA (US); Nairwita Mazumder, San Jose, CA (US); Stephen S. Hadinger, Berkeley, CA (US)

(21) Appl. No.: 19/042,614

(22) Filed: Jan. 31, 2025

(51) Int. Cl. G06Q 10/087; G01G 23/18; G05D 1/667; G06V 20/52

(52) U.S. Cl. CPC G06Q 10/087; G01G 23/18; G05D 1/667; G06V 20/52

(57) ABSTRACT

In some embodiments, apparatuses and methods are provided herein useful to returning unwanted items collected by a user at a facility. In some embodiments, a system for returning unwanted items includes a drop zone repository unit. The unit includes a receptacle; a sensor; and a camera; and a control circuit. The control circuit executes computer program code to: determine that the user returned unwanted items; create a drop zone virtual acquisition listing; associate the unwanted items with the drop zone virtual acquisition listing and an identifier associated with the user; and provide the drop zone virtual acquisition listing and the identifier to an item acquisition system such that at acquisition completion, the drop zone virtual acquisition listing is processed and aggregated with collected virtual acquisition listings to remove the unwanted items in the drop zone virtual acquisition listing from an acquisition transaction.

### TECHNICAL FIELD

This disclosure relates generally to returning unwanted items at a facility.

### BACKGROUND

Generally, as a customer shops a retail store, the customer walks to several areas/locations in the retail store to pick up items for purchase. However, while shopping, the customer may change its mind and decide that it no longer wants the item. Generally, some customers may return the item back to the shelf where it belongs. However, some customers may just leave the item onto a shelf closest to the customers. In other words, some customers may just leave the item in random places in the retail store. As such, there is a need for returning unwanted items while shopping in the retail store to be more accessible.

### BRIEF DESCRIPTION OF DRAWINGS

Disclosed herein are embodiments of systems, apparatuses and methods pertaining to returning unwanted items collected by a user, such as a customer at a facility, such as a retail store. This description includes drawings, wherein:

FIG. 1 illustrates an example system for returning unwanted items collected by a customer at a retail store in accordance with some embodiments;

FIG. 2 is an example diagram illustrating returning unwanted items at the retail store in accordance with several embodiments;

FIG. 3 is an example drop zone repository unit in accordance with some embodiments;

FIG. 4 is an example receptacle of a drop zone repository unit in accordance with several embodiments;

FIG. 5 is a flow diagram depicting example method for returning unwanted items collected by a customer at a retail store in accordance with some embodiments;

FIG. 6 is a block diagram depicting a machine readable medium encoded with example instructions to return unwanted items collected by a customer at a retail store in accordance with several embodiments; and

FIG. 7 illustrates an example algorithm or methodology during image analysis to track and/or identify a presence of a person 702 from one area to another in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to returning unwanted items collected by a user at a facility. In some embodiments, a system for returning unwanted items collected by a user at a facility includes a drop zone repository unit and a control circuit. In some embodiments, the drop zone repository unit includes a receptacle to receive one or more unwanted items from the user acquiring items at the facility; a sensor proximate the receptacle and configured to detect the one or more unwanted items placed into the receptacle by the user; and/or a camera to capture an image of the user proximate the drop zone repository unit. In some embodiments, the control circuit executes computer program code to: analyze the image to attempt to identify a presence of the user and/or one or more items; determine that the user returned the one or more unwanted items based on a determination, using the image analysis, that the user is depicted in the image and a detection of the one or more unwanted items returned by the user; create a drop zone virtual cart based on determining that the user returned the one or more unwanted items; associate the one or more unwanted items with the drop zone virtual acquisition list and an identifier associated with the user; and provide the drop zone virtual acquisition list and the identifier to an item acquisition system such that at acquisition completion, the drop zone virtual acquisition list is processed and aggregated with one or more purchase virtual acquisition lists to remove the one or more unwanted items in the drop zone virtual acquisition list from an acquisition transaction.

In some embodiments, a method for returning unwanted items at a facility includes receiving, at a receptacle of a drop zone repository unit, one or more unwanted items from a user acquiring items at the facility. Alternatively or in addition, the method may include detecting, by a sensor proximate the receptacle of the drop zone repository unit, the one or more unwanted items placed into the receptacle by the user. Alternatively or in addition, the method may include capturing, by a digital camera of the drop zone repository unit, an image of the user proximate the drop zone repository unit. Alternatively or in addition, the method may include analyzing, by a control circuit executing computer program code, the image to attempt to identify a presence of the user and/or one or more items. Alternatively or in addition, the method may include determining, by the control circuit executing computer program code, that the user returned the one or more unwanted items based on a determination, using the image analysis, that the user is depicted in the image and a detection of the one or more unwanted items returned by the user. Alternatively or in addition, the method may include creating, by the control circuit executing the computer code, a drop zone virtual acquisition list based on determining that the user returned the one or more unwanted items. Alternatively or in addition, the method may include associating, by the control circuit executing the computer code, the one or more unwanted items with the drop zone virtual acquisition list and an identifier associated with the user. Alternatively or in addition, the method may include providing, by the control circuit executing the computer code, the drop zone virtual acquisition list and the identifier to an item acquisition system such that at acquisition completion, the drop zone virtual acquisition list is processed and aggregated with one or more collected virtual acquisition lists to remove the one or more unwanted items in the drop zone virtual acquisition list from an acquisition transaction.

In some embodiments, a non-transitory machine readable medium storing instructions for returning unwanted items at a facility that, when executed by a control circuit, cause the control circuit to receive, at a receptacle of a drop zone repository unit, one or more unwanted items from a user acquiring items at the facility. Alternatively or in addition, the instructions when executed by the control circuit, cause the control circuit to detect, by a sensor proximate the receptacle of the drop zone repository unit, the one or more unwanted items placed into the receptacle by the user. Alternatively or in addition, the instructions when executed by the control circuit, cause the control circuit to capture, by a digital camera of the drop zone repository unit, an image of the user proximate the drop zone repository unit. Alternatively or in addition, the instructions when executed by the control circuit, cause the control circuit to analyze the image to attempt to identify a presence of the user and/or one or more items. Alternatively or in addition, the instructions when executed by the control circuit, cause the control circuit to determine that the user returned the one or more unwanted items based on a determination, using image analysis, that the user is depicted in the image and a detection of the one or more unwanted items returned by the user. Alternatively or in addition, the instructions when executed by the control circuit, cause the control circuit to create a drop zone virtual acquisition list based on determining that the user returned the one or more unwanted items. Alternatively or in addition, the instructions when executed by the control circuit, cause the control circuit to associate the one or more unwanted items with the drop zone virtual acquisition list and an identifier associated with the user. Alternatively or in addition, the instructions when executed by the control circuit, cause the control circuit to provide the drop zone virtual acquisition list and the identifier to an item acquisition system such that at acquisition completion, the drop zone virtual acquisition list is processed and aggregated with one or more collected virtual acquisition lists to remove the one or more unwanted items in the drop zone virtual acquisition list from an acquisition transaction.

The following description is not to be taken in a limiting sense but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in but is not limited to at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

This disclosure uses examples of products in stores that may be purchased in purchase transactions; however, these terms can more generically be referred to in acquisition completion terms, e.g., where an item or service is intended to be acquired, and this acquisition is to be completed. This disclosure is broadly directed to any of the various types of transactions that involve some form of acquisition completion. For example, in some embodiments, one or more of: a store may be more generically referred to as a facility; a product may be more generically referred to as an item; an unwanted product or product to be returned may be more generically referred to as an unwanted item; a consumer may be more generically referred to as a user; a virtual cart may be more generically referred to as a virtual acquisition list; a drop zone virtual cart may be more generically referred to as a drop zone virtual acquisition list; a checkout virtual cart may be more generically referred to as a collected virtual acquisition list; a checkout may be more generically referred to as acquisition completion; and a purchase transaction may be more generically referred to as an acquisition transaction.

Further, the embodiments described herein allow for reduction of shrink caused by lost items or items destroyed to sell. Moreover, the items are returned to their planogram compliant location faster than not having a drop zone repository unit. Furthermore, another advantage of having a drop zone repository unit operably coupled to a control circuit as described herein allows for a seamless shopping at a retail stored, whereby the time the customer is at a checkout station or checkout area, the purchase transaction is nearly, if not, already completed. As such, the customer may just zip through the checkout station or checkout area since the items collected and returned by customer while shopping are electronically tallied in the background unbeknownst to the customer.

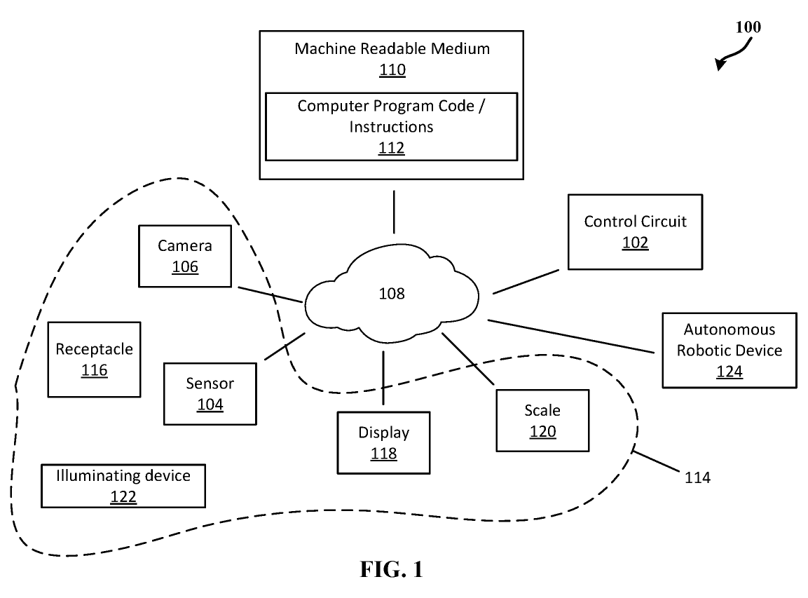

FIG. 1 illustrates an example system 100 for returning unwanted items collected by a customer at a retail store in accordance with some embodiments. The system 100 includes a control circuit 102, a machine readable medium 110 storing computer program code or instructions 112, autonomous robotic device(s) 124, and/or a drop zone repository unit 114 communicatively coupled to one another via a communication network 108. In some embodiments, the drop zone repository unit 114 may include camera(s) 106 (e.g., digital cameras), sensor(s) 104, display(s) 118, scale(s) 120, and/or a receptacle 116. The communication network 108 may include a wired and/or a wireless network, Internet, a local area network, a private network, any public and/or private network that allows electronic devices to communicate to one another, or any combination thereof. The sensor 104 may include at least one of a camera, a radio frequency identification (RFID) reader, a machine-readable code reader (e.g., a barcode reader, a quick response (QR) code, or any electronic device configured to detect the unwanted items placed into a receptacle), or any combination thereof. The control circuit 102 may include one or more processors or any hardware component in a circuit board of a smart device or a computer that receives information from an input, fulfills a command, and delivers the result to a designated output. In some embodiments, the autonomous robotic device(s) 124 may retrieve the one or more returned items from the drop zone repository unit 114.

The machine readable medium 110 may include read only memory (ROM), random access memory (RAM), hard disk drives, solid state drive, to name a few, or any one or more electronic devices capable of storing electronic data and accessible locally and/or remotely (cloud-based storage). In some embodiments, the machine readable medium 110 stores computer program code/instructions 112 that, when executed by the control circuit 102, cause the control circuit 102 to execute the computer program code/instructions 112.

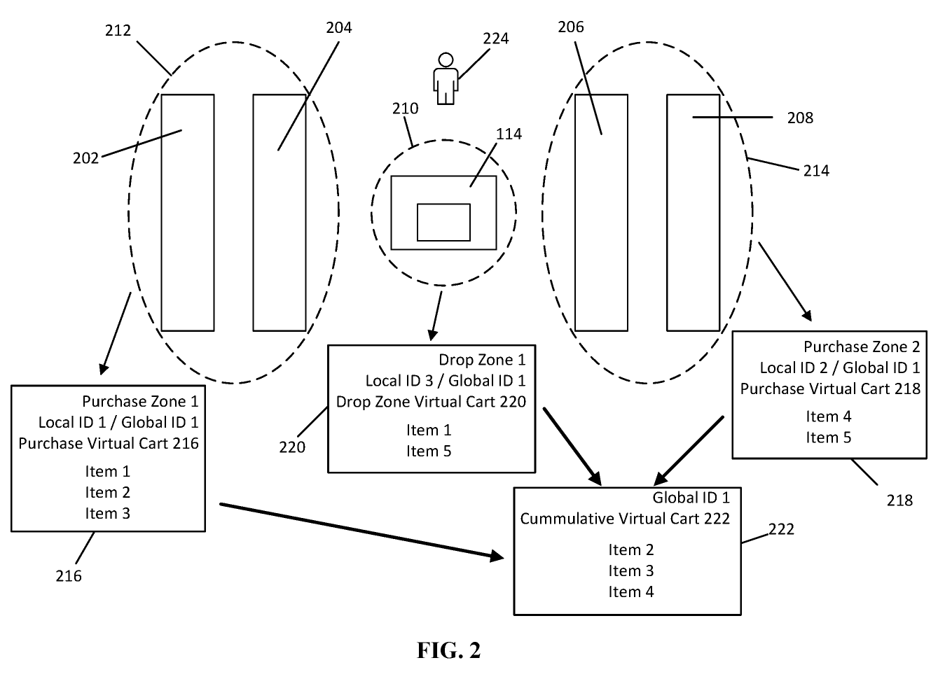

FIG. 2 is an example diagram illustrating returning unwanted items at a retail store in accordance with several embodiments. In an illustrative non-limiting example, a retail store has four aisles 202, 204, 206, 208 and a drop zone repository unit 114. Although FIG. 2 depicts a single drop zone repository unit 114, it is understood that the disclosure described herein is applicable to a plurality of drop zone repository units 114. In some embodiments, the control circuit 102 may assign each aisle and/or areas in the retail store to a respective segment. In some embodiments, a segment includes at least one of one or more aisles, one or more shelves, and one or more areas in the retail store, or any combination thereof. In some aspects, the one or more areas includes a fresh produce area, a deli area, a meat and seafood area, a dairy area, a bakery area, a frozen food area, a cereal and breakfast food area, a canned and packaged good area, and/or a non-food item area, to name a few. For example, in FIG. 2, aisle 202 and aisle 204 are assigned to segment 212 while aisle 206 and aisle 208 are assigned to segment 214. In some embodiments, an area proximate and/or within a distance radius to a drop zone repository unit 114 is assigned to segment 114. In some embodiments, each drop zone repository unit 114 is assigned to its respective segment.

For example, when a customer 224 is in segment 212, the control circuit 102 may determine that the customer collected an item located in aisle 204 based the control circuit 102 processing images captured by one or more cameras 106. In some embodiments, the one or more cameras 106 are mounted such that the images captured by the cameras 106 and processed by the control circuit 102 depict an action by the customer 224 amounting to collecting the item. In some embodiments, for each segment, the control circuit 102 associates a local anonymous identifier with the customer 224. As such, a customer may be associated with a number of local anonymous identifiers depending on the number of segments the customer is determined to have collected an item. In such embodiments, the control circuit 102 may determine that these local anonymous identifiers assigned to customers corresponds to a single customer. The control circuit 102 may then assign a global anonymous identifier to be associated with the customer. Alternatively, the control circuit 102 may anonymously track a customer traversing from one segment to another segment. The control circuit 102 may assign a global anonymous identifier to be associated with the customer.

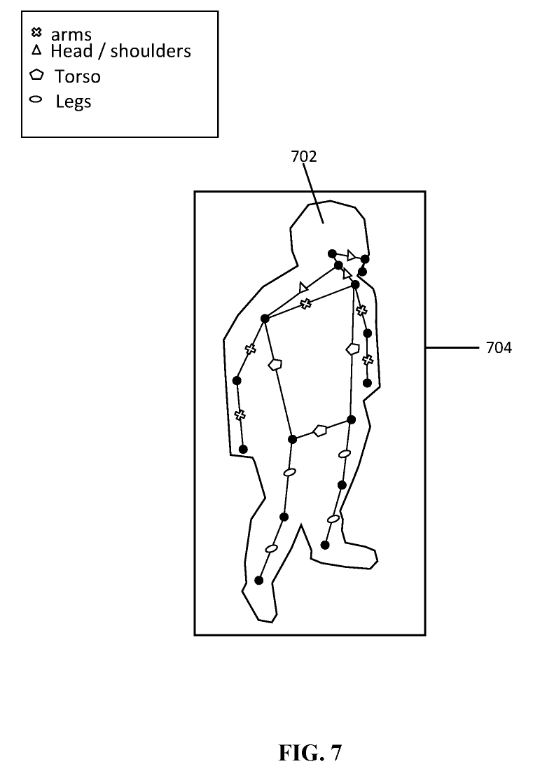

FIG. 7 illustrates an example algorithm or methodology as part of image analysis to track and/or identify a presence of a person 702 from one area to another in accordance with some embodiments. The view shown in FIG. 7 may be, for example, a view from a camera 106 used in anonymously tracking a person moving through a facility. The control circuit 102 may receive an image, or a series of images, from the camera 106, which includes a person 702 within the field of view of the camera 106 and identify and/or superimpose a boundary box 704 around some or all of the image of the person 702. Some embodiments may determine one or more vectors, characteristics, and/or motion lines over the person 702. The boundary box 704, vectors, the motion lines, etc. can be used to track the user (e.g., generally move with movement of the person 702) such that the motion lines and/or other characteristics will correspond with the same portions of the person 702 regardless of the position of the person 702. The boundary box 704, generated vectors, colors, patterns, motion lines and/or other such characteristics can be utilized by the control circuit 102 to track movement of the person 702 relative to the items at the facility and/or the drop zone repository unit and to identify when the person 702 has interacted with an item and/or the drop zone repository unit to the extent that the item should be allocated to a virtual acquisition list that is associated with a drop zone and/or virtual zone and/or a user identifier (e.g., local anonymous identifier and/or global anonymous identifier). In some embodiments, the control circuit 102 may use a similar boundary box 704, generated vectors, colors, patterns, motion lines and/or other such characteristics to identify the person 702 (e.g., by mapping relative to the person’s facial features, body features, clothing features, etc.).

In some embodiments, there are other algorithms or methodologies used to track humans from one area to another area in a facility that are publicly known and as such not needed to be described in detail herein.

In some embodiments, for each segment where the customer collects an item, the control circuit 102 creates a respective virtual zone cart (cart is more generically referred to as acquisition list) and associates the respective virtual zone cart with the local or global anonymous identifier when the customer collects/picks an initial item from each segment. In some aspects, a segment is a location in a particular area on a salesfloor in the retail store. For example, the salesfloor may be partitioned into a plurality of segments, where each segment corresponds to a respective area on the salesfloor and is associated with the respective virtual zone cart, such that items collected/picked by the customer while shopping at the particular area on the salesfloor are associated with the respective virtual zone cart. For example, the control circuit 102 creates purchase virtual zone cart 216 and associate it with customer 224 and segment 212 since in segment 212 the customer 224 collected/picked at least one item. By one approach, the control circuit 102 assigns a local anonymous identifier 1 and/or a global anonymous identifier 1 of the customer 224 with purchase virtual zone cart 216. In some embodiments, the control circuit 102 creates purchase virtual zone cart 218 and associate it with the customer 224 and segment 214 since in segment 214 the customer 224 collected/picked at least one item. By one approach, the control circuit 102 assigns a local anonymous identifier 2 and/or the global anonymous identifier 1 of the customer 224 with purchase virtual zone cart 218.

In an illustrative non-limiting example, the control circuit 102 determines that the customer 224 intends to not purchase one or more unwanted items (more generically referred to as returning unwanted items) based on a determination that the customer 224 is depicted in the captured image and a detection of the one or more unwanted items returned by the customer 224 (more generically referred to as received at the receptacle). In some embodiments, the control circuit 102 initiates a return process based on at least one of the determination that the customer 224 is depicted on the captured image and the detection of the one or more unwanted items returned by the customer 224. In some embodiments, the control circuit 102 may determine that at least one of the one or more unwanted items is returned at a wrong drop zone repository unit based on an item identifier associated with the at least one of the one or more unwanted items (e.g., a machine-readable code associated with the returned item). Alternatively or in addition, the control circuit 102 may transmit a notification to a user device associated with an associate indicating to move the at least one of the one or more unwanted items back to an intended storage location. For example, it a perishable item requiring refrigeration is dropped in a drop zone repository unit that does not have refrigeration, the control circuit 102 transmits a notification to a user device of an associate indicating to move the perishable item to the intended storage location (that is, place the perishable item back to its designation place).

In some embodiments, one or more sensors 104 are proximate a receptacle of a drop zone repository unit and detect the one or more unwanted items placed into the receptacle by the customer 224. In some embodiments, the control circuit 102 creates a drop zone virtual cart 220 (more generically referred to as drop zone virtual acquisition list) based on determining that the customer 224 intends to not purchase the one or more unwanted items. For example, by placing the unwanted items into the receptacle, the control circuit 102 determines that customer 224 intends to not purchase these items. Alternatively or in addition, the control circuit 102 may associate the unwanted items with the drop zone virtual cart 220 and an identifier associated with the customer (e.g., the local anonymous identifier 3 assigned by the control circuit 102 and/or the global anonymous identifier 3). Alternatively or in addition, the control circuit 102 may provide the drop zone virtual cart 220 and the identifier (local or global) to a point of sale system. As such, at checkout (more generically referred to as acquisition completion) (e.g., at a checkout station or area), the drop zone virtual cart 220 may be processed and aggregated with one or more purchase virtual carts 216, 218 (more generically referred to as collected virtual acquisition lists) to remove the unwanted items in the drop zone virtual cart 220 from a purchase transaction (more generically referred to as acquisition transaction).

For example, in processing the drop zone virtual cart 220 with the aggregated purchase virtual carts 216, 218, the control circuit 102 creates a cumulative virtual cart 222. In some embodiments, the control circuit 102 assigns the global anonymous identifier 1 with the cumulative virtual cart 222 and/or customer 224. For example, the control circuit 102 has associated item 1, item 2, and item 3 (items collected by the customer 224 in segment 212) with purchase virtual cart 216. In some embodiments, the control circuit 102 has associated item 4 and item 5 (items collected by the customer 224 in segment 214) with purchase virtual cart 218. In some embodiments, the control circuit 102 has associated item 1 and item 5 (items returned by the customer 224 at drop zone 210) with drop zone virtual cart 220. Alternatively or in addition, after processing the drop zone virtual cart 220 with the aggregated purchase virtual carts 216, the control circuit 102 removes item 1 and item 5 from the tally. As such, the items associated with the cumulative virtual cart 222 are items finally tallied for purchase by the customer 224. For example, the remaining items to be purchased by the customer 224 are item 2, item 3, and item 4 as illustrated in FIG. 2.

In another illustrative non-limiting example, the control circuit 102 may associate an identifier (e.g., a local anonymous identifier and/or a global anonymous identifier) with a customer 224. Alternatively or in addition, the control circuit 102 may create a respective virtual zone cart and associate the respective virtual zone cart with the identifier when the customer collect/picks an initial item from a location in a particular area on a salesfloor in the retail store, where the salesfloor is partitioned into a plurality of segments. In some embodiments, each segment corresponds to a respective area on the salesfloor and is associated with the respective virtual zone cart, where items picked by the customer while shopping at the particular area on the salesfloor are associated with the respective virtual zone cart. Alternatively or in addition, the control circuit 102 may determine the returned unwanted items associated with the drop zone virtual cart of the identifier. Alternatively or in addition, the control circuit 102 may combine items associated with virtual zone carts of the identifier into a cumulative virtual cart (e.g., the cumulative virtual cart 222 of FIG. 2). Alternatively or in addition, the control circuit 102 may determine items to be purchased by the customer 224 by removing items associated with the cumulative virtual cart that correspond to the returned unwanted items associated with the drop zone virtual cart.

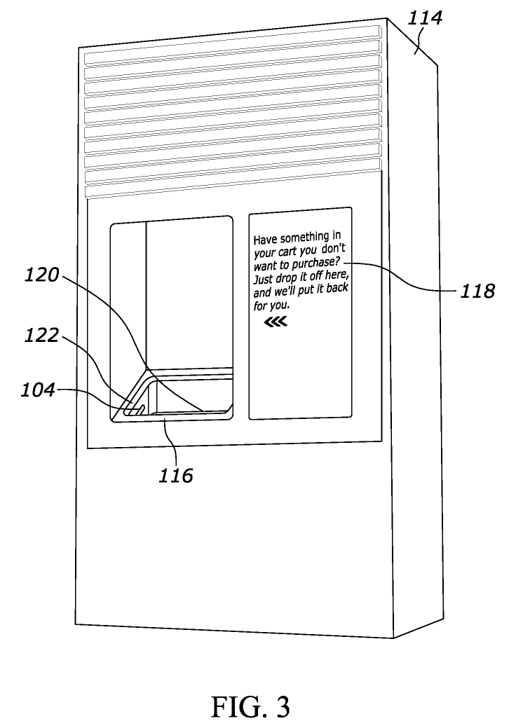

FIG. 3 is an example drop zone repository unit 114 in accordance with some embodiments. The drop zone repository unit 114 may include a display 118, a scale 120, a sensor 104, an illuminating device 122, and/or a receptacle 116. In some embodiments, the sensor 104 includes at least one of a barcode reader, a camera, and/or a radio frequency identification (RFID) reader. In some embodiments, the display 118 indicates to the customer that at least one of: a return process has been initiated and/or the one or more unwanted items have been successfully returned. In some embodiments, the scale 120 measures a weight and/or a mass of the one or more unwanted items. In some embodiments, an illuminating device 122 may visually communicate to the customer a current status of a return process. For example, the illuminating device 122 may lit green when the return process has been successfully completed. In another example, the illuminating device 122 may lit red when the return process has not been successfully completed.

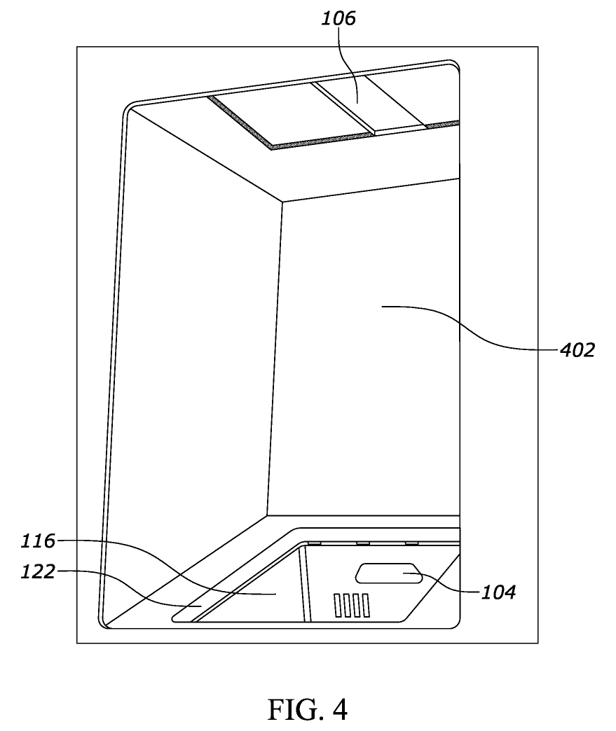

FIG. 4 is an example receptacle 116 of a drop zone repository unit 114 in accordance with several embodiments. In some embodiments, the receptacle 116 includes a sensor 104 and an illuminating device 122. Alternative or in addition, a camera 106 may be mounted above the receptacle 116. In some embodiments, camera 106 and/or an additional camera may be mounted to view a customer located in front of the drop zone repository (e.g., to obtain an image such as shown in FIG. 7 for image analysis). In some embodiments, the receptacle 116 may be located in a recessed 402 portion of the drop zone repository unit 114.

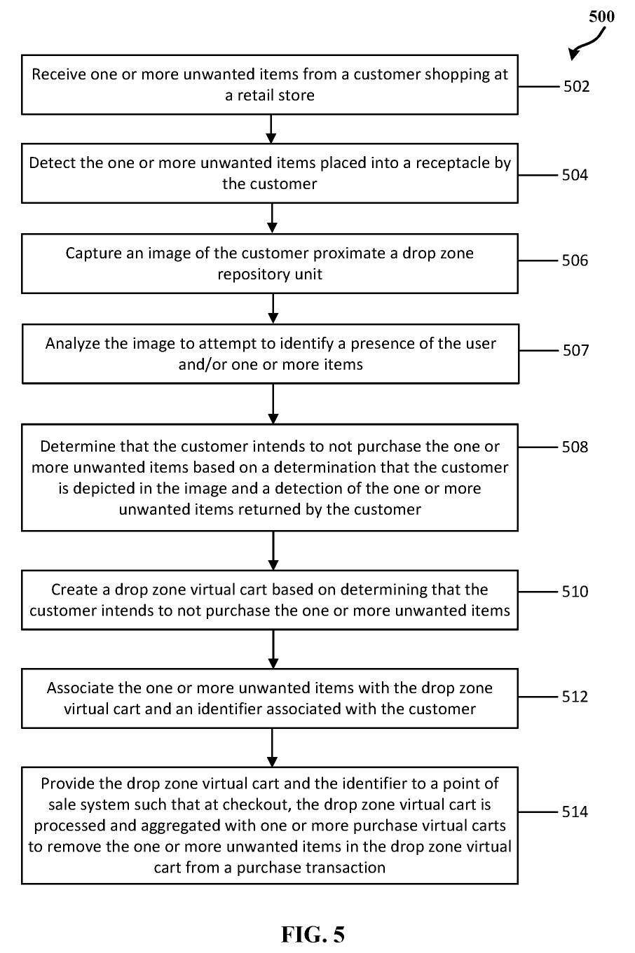

FIG. 5 is a flow diagram depicting example method 500 for returning unwanted items collected by a customer at a retail store in accordance with some embodiments. In some embodiments, the method 500 may be implemented and/or executed by the system 100 of FIG. 1 and/or the control circuit 102 of FIG. 1. In some embodiments, the method 500 includes, at step 502, receiving, at a receptacle of a drop zone repository unit, one or more unwanted items from a customer shopping at the retail store (more generically referred to as user acquiring items). Alternatively or in addition, the method 500 may include, at step 504, detecting, by a sensor proximate the receptacle of the drop zone repository unit, the one or more unwanted items placed into the receptacle by the customer. Alternatively or in addition, the method 500 may include, at step 506, capturing, by a camera (e.g., a digital camera) of the drop zone repository unit, an image of the customer proximate the drop zone repository unit. Alternatively or in addition, the method 500 may include, at step 507, analyzing (e.g., by the control circuit) the image to attempt to identify a presence of the customer and/or more items. For example, in some embodiments, FIG. 7 illustrates an image analysis process to identify the presence of the customer. Alternatively or in addition, the method 500 may include, at step 508, determining, by a control circuit executing computer program code, that the customer intends to not purchase the one or more unwanted items based on a determination that the customer is depicted in the image and a detection of the one or more unwanted items returned by the customer. Alternatively or in addition, the method 500 may include, at step 510, creating, by the control circuit executing the computer code, a drop zone virtual cart based on determining that the customer intends to not purchase the one or more unwanted items. Alternatively or in addition, the method 500 may include, at step 512, associating, by the control circuit executing the computer code, the one or more unwanted items with the drop zone virtual cart and an identifier associated with the customer. Alternatively or in addition, the method 500 may include, at step 514, providing, by the control circuit executing the computer code, the drop zone virtual cart and the identifier to a point of sale system such that at checkout, the drop zone virtual cart is processed and aggregated with one or more purchase virtual carts to remove the one or more unwanted items in the drop zone virtual cart from a purchase transaction.

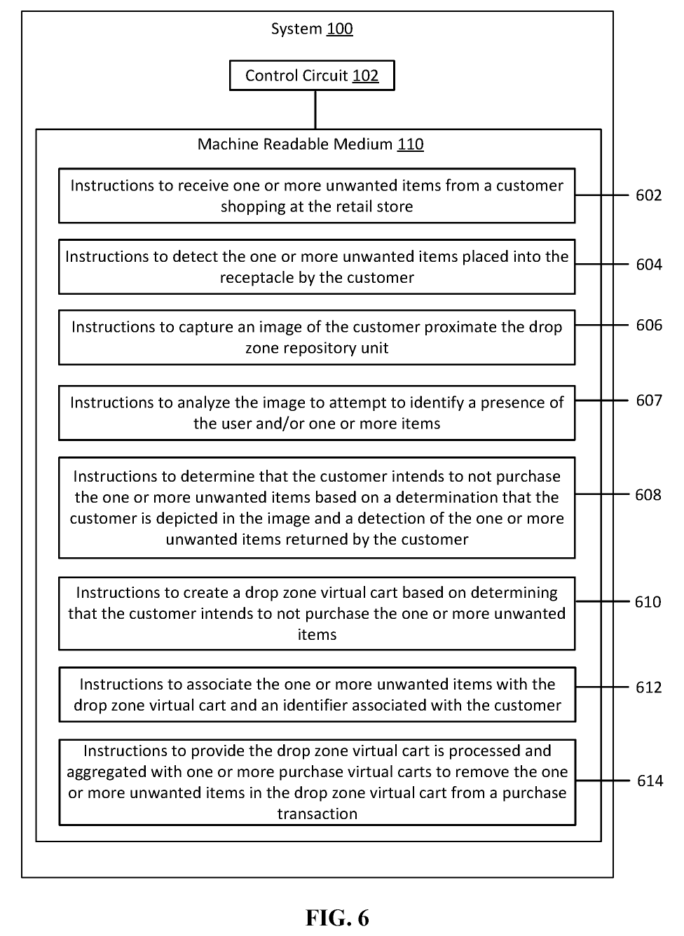

FIG. 6 depicts a control circuit 102 coupled to a non-transitory machine readable medium 110 encoded with example instructions 602, 604, 606, 608, 610, 612, 614. The control circuit 102 and medium 110 may be implemented on the system 100. The instructions may be an implementation of returning unwanted items at a retail store.

Instructions 602, when executed, cause the control circuit 102 to receive, at a receptacle of a drop zone repository unit, one or more unwanted items from a customer shopping at the retail store.

Instructions 604, when executed, cause the control circuit 102 to detect, by a sensor proximate the receptacle of the drop zone repository unit, the one or more unwanted items placed into the receptacle by the customer.

Instructions 606, when executed, cause the control circuit 102 to capture, by a camera of the drop zone repository unit, an image of the customer proximate the drop zone repository unit.

Instructions 607, when executed, cause the control circuit 102 to analyze the image to attempt to identify a presence of the customer and/or more items. For example, in some embodiments, FIG. 7 illustrates an image analysis process to identify the presence of the customer.

Instructions 608, when executed, cause the control circuit 102 to determine, by a control circuit executing computer program code, that the customer intends to not purchase the one or more unwanted items based on a determination that the customer is depicted in the image and a detection of the one or more unwanted items returned by the customer.

Instructions 610, when executed, cause the control circuit 102 to create a drop zone virtual cart based on determining that the customer intends to not purchase the one or more unwanted items.

Instructions 612, when executed, cause the control circuit 102 to associate the one or more unwanted items with the drop zone virtual cart and an identifier associated with the customer.

Instructions 614, when executed, cause the control circuit 102 to provide the drop zone virtual cart and the identifier to a point of sale system such that at checkout, the drop zone virtual cart is processed and aggregated with one or more purchase virtual carts to remove the one or more unwanted items in the drop zone virtual cart from a purchase transaction.

Further details regarding identifying users from images and assigning unique identifiers to users are described in the following patent applications, all of which are incorporated herein in their entirety by reference: U.S. Non-Provisional No. 19/042,405, filed 1-31-2025, titled SYSTEMS AND METHODS OF IDENTIFYING AND ALLOCATING PRODUCTS WITHIN A RETAIL FACILITY, (Docket No. 8842-160374-US_8870US01); and U.S. Non-Provisional No. 19/042,457, filed 1-31-2025, titled SYSTEMS AND METHODS OF CONTROLLING SEGMENTATION AND PRODUCT CORRELATION WITHIN A RETAIL FACILITY, (Docket No. 8842-160375-US_8871US01).

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system for returning unwanted items collected at a facility, the system comprising:
a drop zone repository unit comprising:
a receptacle to receive one or more unwanted items from a user acquiring items at the facility;
a sensor proximate the receptacle and configured to detect the one or more unwanted items placed into the receptacle by the user; and
a digital camera to capture an image of the user proximate the drop zone repository unit; and
a control circuit executing computer program code to:
analyze the image to attempt to identify a presence of the user and/or one or more items;
determine that the user has returned the one or more unwanted items based on a determination, using the image analysis, that the user is depicted in the image and a detection of the one or more unwanted items received at the receptacle;
create a drop zone virtual acquisition list based on determining using the image analysis that the user returned the one or more unwanted items;
associate the one or more unwanted items with the drop zone virtual acquisition list and an identifier associated with the user; and
provide the drop zone virtual acquisition list and the identifier to an item acquisition system such that at acquisition completion, the drop zone virtual acquisition list is processed and aggregated with one or more collected virtual acquisition lists to remove the one or more unwanted items in the drop zone virtual acquisition list from an acquisition transaction.

2. The system of claim 1, wherein the sensor comprises at least one of a barcode reader, a camera, and/or a radio frequency identification (RFID) reader.

3. The system of claim 1, wherein the control circuit is configured to initiate a return process based on at least one of the determination that the user is depicted on the image and the detection of the one or more unwanted items returned by the user.

4. The system of claim 1, wherein the drop zone repository unit further comprises a display to indicate to the user that at least one of: a return process has been initiated and/or the one or more unwanted items have been successfully returned.

5. The system of claim 1, wherein the drop zone repository unit further comprises a scale configured to measure a weight and/or a mass of the one or more unwanted items.

6. The system of claim 1, wherein the control circuit is configured to:
determine that at least one of the one or more unwanted items is returned at a wrong drop zone repository unit based on an item identifier associated with the at least one of the one or more unwanted items; and
transmit a notification to a user device associated with an associate indicating to move the at least one of the one or more unwanted items back to an intended storage location.

7. The system of claim 1, wherein the drop zone repository unit further comprises an illuminating device configured to visually communicate to the user a current status of a return process.

8. The system of claim 1, further comprising an autonomous robotic device configured to retrieve the one or more returned unwanted items from the drop zone repository unit.

9. The system of claim 1, wherein the control circuit is further configured to:
associate the identifier with the user;
create a respective virtual zone acquisition list and associate the respective virtual zone acquisition list with the identifier when the user picks an initial item from a location in a particular area on a salesfloor in the facility, wherein the salesfloor is partitioned into a plurality of segments, wherein each segment corresponds to a respective area on the salesfloor and is associated with the respective virtual zone acquisition list, wherein items picked by the user while acquiring items at the particular area on the salesfloor are associated with the respective virtual zone acquisition list;
determine returned unwanted items associated with the drop zone virtual acquisition list of the identifier;
combine items associated with virtual zone acquisition lists of the identifier into a cumulative virtual acquisition list; and
determine items to be acquired by the user by removing items associated with the cumulative virtual acquisition list that correspond to the returned unwanted items associated with the drop zone virtual acquisition list.

10. The system of claim 9, wherein a segment comprises at least one of one or more aisles and one or more areas in the facility, wherein the one or more areas comprise a fresh produce area, a deli area, a meat and seafood area, a dairy area, a bakery area, a frozen food area, a cereal and breakfast food area, a canned and packaged good area, a non-food item area.

11. A method for returning unwanted items at a facility, the method comprising:
receiving, at a receptacle of a drop zone repository unit, one or more unwanted items from a user acquiring items at the facility;
detecting, by a sensor proximate the receptacle of the drop zone repository unit, the one or more unwanted items placed into the receptacle by the user;
capturing, by a digital camera of the drop zone repository unit, an image of the user proximate the drop zone repository unit;
analyzing, by a control circuit executing computer program code, the image to attempt to identify a presence of the user and/or one or more items;
determining, by the control circuit executing computer program code, that the user has returned the one or more unwanted items based on a determination, using the image analysis, that the user is depicted in the image and a detection of the one or more unwanted items received at the receptacle;
creating, by the control circuit executing the computer program code, a drop zone virtual acquisition list based on using the image analysis determining that the user returned the one or more unwanted items;
associating, by the control circuit executing the computer program code, the one or more unwanted items with the drop zone virtual acquisition list and an identifier associated with the user; and
providing, by the control circuit executing the computer program code, the drop zone virtual acquisition list and the identifier to an item acquisition system such that at acquisition completion, the drop zone virtual acquisition list is processed and aggregated with one or more collected virtual acquisition lists to remove the one or more unwanted items in the drop zone virtual acquisition list from an acquisition transaction.

12. The method of claim 11, wherein the sensor comprises at least one of a barcode reader, a camera, and/or a radio frequency identification (RFID) reader.

13. The method of claim 11, further comprising initiating, by the control circuit executing the computer program code, a return process based on at least one of the determination that the user is depicted on the image and the detection of the one or more unwanted items received at the receptacle.

14. The method of claim 11, further comprising indicating to the user, by a display of the drop zone repository unit, that at least one of: a return process has been initiated and/or the one or more unwanted items have been successfully received at the receptacle.

15. The method of claim 11, further comprising:
determining, by the control circuit executing the computer program code, that at least one of the one or more unwanted items is returned at a wrong drop zone repository unit based on an item identifier associated with the at least one of the one or more unwanted items; and
transmitting, by the control circuit executing the computer program code, a notification to a user device associated with an associate indicating to move the at least one of the one or more unwanted items back to an intended storage location.

16. The method of claim 11, further comprising visually communicating to the user, by an illuminating device of the drop zone repository unit, a current status of a return process.

17. The method of claim 11, further comprising retrieving, by an autonomous robotic device, the one or more returned items from the drop zone repository unit.

18. The method of claim 11, further comprising:
associating, by the control circuit executing the computer program code, the identifier with the user;
creating, by the control circuit executing the computer program code, a respective virtual zone acquisition list and associate the respective virtual zone acquisition list with the identifier when the user picks an initial item from a shelf located in a particular area on a salesfloor in the facility, wherein the salesfloor is partitioned into a plurality of segments, wherein each segment corresponds to a respective area on the salesfloor and is associated with the respective virtual zone acquisition list, wherein items picked by the user while shopping at the particular area on the salesfloor are associated with the respective virtual zone acquisition list;
determining, by the control circuit executing the computer program code, returned unwanted items associated with the drop zone virtual acquisition list of the identifier;
combining, by the control circuit executing the computer program code, items associated with virtual zone acquisition lists of the identifier into a cumulative virtual acquisition list; and
determining, by the control circuit executing the computer program code, items to be purchased by the user by removing items associated with the cumulative virtual acquisition list that correspond to the returned unwanted items associated with the drop zone virtual acquisition list.

19. A non-transitory machine readable medium storing instructions for returning unwanted items at a facility that, when executed by a control circuit, cause the control circuit to:
receive, at a receptacle of a drop zone repository unit, one or more unwanted items from a user acquiring items at the facility;
detect, by a sensor proximate the receptacle of the drop zone repository unit, the one or more unwanted items placed into the receptacle by the user;
capture, by a digital camera of the drop zone repository unit, an image of the user proximate the drop zone repository unit;
analyze the image to attempt to identify a presence of the user and/or one or more items;
determine that the user has returned the one or more unwanted items based on a determination, using the image analysis, that the user is depicted in the image and a detection of the one or more unwanted items received at the receptacle;
create a drop zone virtual acquisition list based on determining using the image analysis that the user returned the one or more unwanted items;
associate the one or more unwanted items with the drop zone virtual acquisition list and an identifier associated with the user; and
provide the drop zone virtual acquisition list and the identifier to an item acquisition system such that at acquisition completion, the drop zone virtual acquisition list is processed and aggregated with one or more collected virtual acquisition lists to remove the one or more unwanted items in the drop zone virtual acquisition list from an acquisition transaction.

20. The non-transitory machine readable medium of claim 19, wherein the instructions, when executed by the control circuit, cause the control circuit to:
retrieve, by an autonomous robotic device, the one or more returned unwanted items from the drop zone repository unit.
